(19) United States
(12) Patent Application Publication
(10) Pub. No.: US 2020/0184518 A1
(43) Pub. Date: Jun. 11, 2020

(54) REMOTELY MANAGED DIGITAL SIGNAGE PLAYER WITH BLE BEACONING

(71) Applicant: DEVICEWORX TECHNOLOGIES INC., Comox (CA)

(72) Inventors: Inderjit BAINS, Vancouver (CA); Mark JANKE, Comox (CA)

(73) Assignee: Deviceworx Technologies Inc., Comox, BC (CA)

(21) Appl. No.: 16/480,672

(22) PCT Filed: Jan. 22, 2018
(86) PCT No.: PCT/CA2018/050073

§ 371 Date: Jul. 24, 2019

Related U.S. Application Data
(60) Provisional application No. 62/449,980, filed on Jan. 24, 2017.

(51) Int. Cl. G06Q 30/02; G06F 16/9537; G06Q 20/36; H04W 4/80; H04W 4/021; H04L 29/08; H04W 4/23

(52) U.S. Cl. CPC G06Q 30/0267; G06F 16/9537; G06Q 30/0261; H04W 4/23; H04W 4/80; H04W 4/021; H04L 67/20; G06Q 20/363

(57) ABSTRACT

Methods, systems, and techniques are disclosed for transmitting advertising packets. The system comprises a beacon device and a display coupled to the beacon device. The device is operable to transmit a Bluetooth Low Energy communications signal and may send an advertisement packet to a user device via the Bluetooth Low Energy communications signal. The device may also display a display message on the display. The display message may correspond to the advertisement packet and may be used to provide information about the advertisement packet and to draw the user's attention to steps to receive the advertisement packet. The advertising packet and the display message may be updated at a remote dashboard. Scheduling of the display of the display message and transmission of the advertisement packets may be used to provide targeted advertising.

### TECHNICAL FIELD

The present disclosure relates to proximity based marketing systems, and in particular, to Bluetooth Low Energy communications based advertising.

### BACKGROUND

In location-based proximity marketing, a peripheral Bluetooth Low Energy (BLE) device can be used to send “advertisement” packets to a central device, such as a Smartphone, Smartwatch, tablet or laptop without the need to establish a Bluetooth connection. The data payload in the BLE packets can include a unique beacon identifier (ID) or a URL (web page address). IDs can be used to provide location-specific context to applications or operating systems so that they can interact with device users in a way that is meaningful for the central device location.

There exists a continuing desire to advance and improve technology related to location based proximity marketing.

### SUMMARY

According to one aspect, there is provided a system for transmitting advertising packets. The system includes a device. The device comprises a computer readable memory and a processor. The system may also include a communications interface coupled to the device and communicatively coupleable with a user device. The communications interface may be operable to transmit a Bluetooth Low Energy communications signal. The system may also comprise an advertisement packet stored on the computer readable memory, a display message corresponding to the advertisement packet, the display message stored on the computer readable memory, and a display communicatively coupled to the device for displaying the display message. The system may further comprise an application stored on the computer readable memory and executable by the processor. The application may comprise an advertising routine for sending the advertisement packet to the user device and a display application module for displaying the display message on the display. The display may be proximate to the user device and the display message may be for providing information for a user of the user device about the advertisement packet sent to the user device.

The advertisement packet may comprise a beacon ID for identifying the geographic location from which the packet is being sent.

The device may simultaneously transmit multiple beacon IDs within multiple packet formats.

The display message may comprise information about enabling reception of the advertisement packet at the user device.

The display message may comprise information about a benefit in receiving the advertisement packet.

The system may comprise an application server. The application server may comprise a server application for configuring a third party lookup server that is communicatively coupleable to the user device for instructing the user device an action to take in response to the beacon ID within the advertising packet being received by the user device.

The server application may be operable for configuring a third party lookup server that is communicatively coupleable to the user device for instructing the user device to launch a user device application and to instruct the application to display information about an advertising promotion.

The system may comprise user device wallet application instructions stored on a server memory of the application server for configuring the third party lookup server for instructing the user device wallet application to display a specific coupon in response to the beacon ID received by the user device.

The system may comprise an updating application stored on the application server and the device, the updating application comprising a configurable function for updating the advertisement packet and the display message.

Updating the advertisement packet may comprise updating an advertisement packet ID.

The updating application may comprise a scheduling module for automatically updating the advertisement packet and the display message based on a configurable schedule.

The display may be integrated with the device.

The updating application may comprise an adaptive scheduling module for automatically updating the advertisement packet and the display message according to an adaptive schedule automatically derived from sales data for an advertised product or service.

The system may comprise a coupon creating application stored at the application server for creating a coupon file and adding an ID to the coupon file. The coupon file may be transmittable to the user device and the ID matching the beacon ID in the advertisement packet.

The system may comprise a user device application stored on the user device. The user device application may comprise a user device module executable in response to the user device receiving the advertisement packet. The user device may be communicatively coupleable to the application server for updating the user device application.

The system may comprise a plurality of devices.

According to another aspect, there is provided a method for localized wireless advertising. The method may comprise transmitting a Bluetooth Low Energy communications signal from a communications interface coupled to a beacon device, sending an advertisement packet stored on a computer readable memory coupled to the beacon device to a user device proximate to the beacon device, wherein the advertisement packet is sent as part of the Bluetooth Low Energy communications signal, and displaying a display message corresponding to the advertisement packet on a display communicatively coupled to the beacon device, the display message providing information for a user of the user device about the advertisement packet sent to the user device.

Providing information for the user of the user device may comprise alerting the user to the advertisement packet sent to the user device.

The method may comprise providing an updating application at an application server communicatively coupled to the beacon device. The updating application may be operable for updating the advertisement packet and the display message.

The beacon device may comprise a plurality of beacon devices, each beacon device having stored thereon a corresponding advertisement packet and message. The updating application may be operable for updating with a first update a first corresponding advertisement packet and display message at a first one of the plurality of beacon devices and with a second update a second corresponding advertisement packet and second message at a second one of the plurality of beacon devices.

The method may comprise providing a configurable schedule and automatically transmitting the advertisement packet based on the configurable schedule.

The method may comprise monitoring sales data related to an advertising campaign and providing a sales analysis application at an application server communicatively coupled to the beacon device for automatically analysing the sales data and automatically configuring the schedule based on the sales data.

Analysing sales data may comprise comparing a quantity of sales during different periods of time.

Displaying the message on the display may comprise displaying the message on the beacon device.

The method may comprise transmitting from the application server an update to a user device application stored on the user device.

The updating application may be further operable for configuring a response of the user device application to the receipt of the advertisement packet by the user device.

Displaying the display message may comprise displaying a message instructing the user on enabling reception of the advertisement packet at the user device.

According to another aspect, there may be provided a computer program product for localized wireless advertising, the computer program product comprising a non-transitory computer-readable medium having computer-readable code embodied therein executable by a processor for performing a method for localized wireless advertising. The method may comprise sending an advertisement packet stored on a computer readable memory coupled to a beacon device to a user device proximate to the beacon device, wherein the advertisement packet is sent as part of a Bluetooth Low Energy communications signal transmitted by the beacon device. The method may also comprise displaying a display message corresponding to the advertisement packet on a display communicatively coupled to the beacon device. The display message may provide information for a user of the user device about the advertisement packet sent to the user device.

### BRIEF DESCRIPTION OF THE DRAWINGS

In the accompanying drawings, which illustrate one or more example embodiments,

FIG. 1 is a block diagram of a remotely managed advertising system with digital signage and Bluetooth Low Energy beaconing, according to one embodiment; and

FIG. 2 shows a method for localized wireless advertising according to one embodiment.

### DETAILED DESCRIPTION

Any directional terms such as “top”, “bottom”, “upper”, “lower”, “left”, “right”, and “vertical” that may be used in the following description are used for the purpose of providing relative reference only, and are not intended to suggest any limitations on how any article is to be positioned during use, or to be mounted in an assembly or relative to an environment. Additionally, the term “couple” and variants of it such as “coupled”, “couples”, “coupling”, and “coupleable” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. The term “coupleable”, as used in the present disclosure, means that a first device is capable of being coupled to the second device. A first device that is communicatively coupleable to a second device has the ability to communicatively couple with the second device but may not always be communicatively coupled.

The term application, as used in this document, refers to a set of instructions executable by a computer processor. The application may be a standalone application or it may be integrated within other applications and systems, such as a computer operating system. A computer, in the context of this document, refers to a device having a processor and a computer readable memory. The memory may be the processor's internal memory. The memory may comprise a separately embodied memory to which the processor has access—e.g. by suitable physical interface, suitable network interface and/or the like.

Despite the rapid adoption of Online Shopping in many retail areas, the brick-and-mortar experience is still an important part of the overall retail market, especially in grocery, clothing, and vehicles. Retailers have started to use proximity marketing to provide shoppers with information on the latest products and special offers. Proximity marketing has traditionally been in the form of digital signage: specially configured TVs or monitors displaying high-resolution (currently up to 4K) still images, videos or 2D/3D animations (the “content”).

A new form of proximity marketing involves a peripheral Bluetooth Low Energy (BLE) peripheral device (beacon device) sending BLE advertisement packets to BLE central user devices including, but not limited to, Smartphones, Smartwatches, tablets or laptops that facilitates the consumer's automatic navigation to a retailer's app screen or web page without any need to explicitly launch an app, select a screen within a running app or type in a web page URL. The data payload in the BLE packets may include a unique beacon identifier (“ID”) or a URL (web page address). IDs may be used to provide location-specific context to applications or operating systems so that they may interact with device users in a way that is meaningful for the user device location. A user device operating system may start a specific app based on the beacon ID and (optionally) may pass the current user device location and the current marketing campaign to the app so that it may automatically display a specific screen or take a specific action relevant to the user device location and currently running campaign. A running app on the user device may use the beacon ID to display a specific screen or take a specific action that is relevant to the user device location. A received URL may be used on the user device to notify its user of a web page that is meaningful for the device location. An example is the display of a coupon or offer for a retailer that is near the user device location. Another example is advertising a URL for a parking lot management company web page to user device users that are visiting a parking lot and may wish to pay for parking on the management company's web page.

A user may need to, however, enable BLE advertisement packet reception on the user's mobile user device. Additionally, the user may not be aware of an action taken by the user device due to the advertisement received by the user device.

The present disclosure provides a beacon device (BLE peripheral device) communicatively coupled with a display for displaying a display message. The display message may be used to direct a potential user's attention to the user's user device and/or provide instructions to enable BLE advertisement packet reception on user devices. In some embodiments, an advertiser may use, for example, a high-resolution (720p, 1080p, 4K, etc.) digital signage monitor. These monitors may also display offers, promotions or ads consisting of still images, videos or 2D/3D animations. Having the BLE peripheral device display the display message on a display proximate a user is advantageous because the BLE peripheral device may display messages on the display alerting the user to check their mobile device. This may make the advertising campaign more effective by making user's aware that advertising material and/or promotions may be available on their mobile devices. Additionally, providing instructions to enable BLE advertisement packet reception on a user device is advantageous because it increases the likelihood that a user will enable advertisement packet reception and receive advertising material or promotions sent by an advertiser.

The present disclosure also provides for BLE advertisement packets and display messages, including but not limited to still images, videos, and 2D/3D animations to be updated through the Internet, via wired connection or through wireless Wi-Fi, or cellular data connections such as 3G, 4G, and LTE, uniquely for each BLE peripheral device, for several BLE peripheral devices with one command, or universally for all BLE peripheral devices under the advertiser's control. This is advantageous by providing a simple and effective system for an advertiser to control their marketing strategy and update their advertising campaigns.

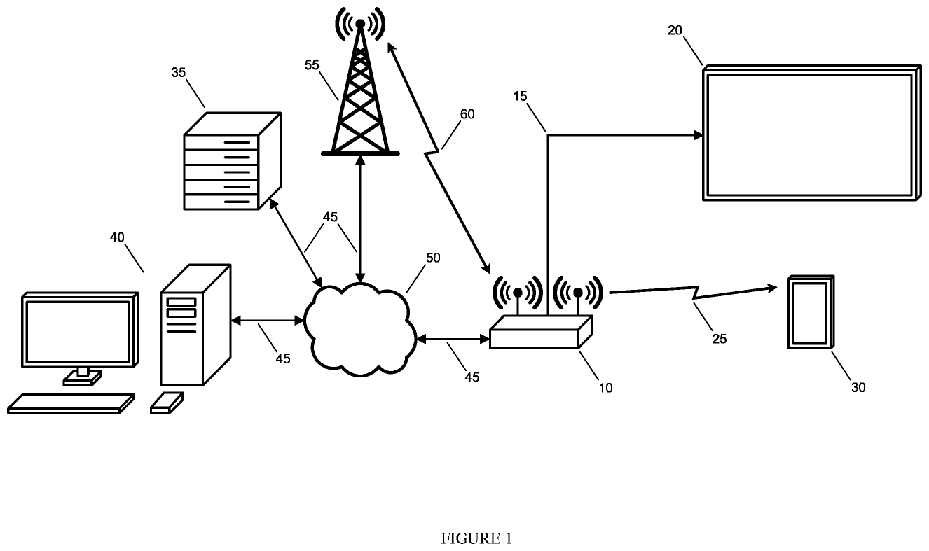

Referring to FIG. 1, an embodiment of a BLE peripheral device 10 is shown. The BLE peripheral device 10 displays a display message, comprising still images, videos, or 2D/3D animations, through an HDMI/DisplayPort or similar cable 15 on a display 20. The display may include, without limitation, a digital signage TV or monitor. The BLE peripheral device 10 sends BLE advertisement packet 25 to a user device 30. The BLE advertisement packet 25 may comprise, for example, a unique beacon ID or web page URL. The user device 30 may comprise any suitable device for receiving the BLE advertisement packet 25. For example, in some embodiments, the user device 30 may comprise a Smartphone, Smartwatch, or tablet. The BLE peripheral device's display message and BLE advertisement packet 25 contents may be updated from an Internet connected application server 35 using a web browser or application (the “dashboard) running on a workstation 40. The internet connections 45 may be, for example, through the Cloud 50. For applications where it is not convenient to use a wired Internet connection 45 between the BLE peripheral device 10 and the Cloud 50, the Internet connection may be a wireless connection through, for example, a Wi-Fi or cellular network 55, with the updates sent over-the-air through, for example, a 3G/4G/LTE, Wi-Fi or future standard wireless data connection 60.

In some embodiments, a system for transmitting advertising packets may comprise a device with a computer readable memory and a processor. A communications interface may be coupled to the device and may be communicatively coupleable with a user device. The communications interface may be operable to transmit a Bluetooth Low Energy communications signal. An advertisement packet and a display message corresponding to the advertisement packet may be stored on the computer readable memory. The system may also comprise an application stored on the computer readable memory and executable by the processor. The application may comprise an advertising routine for sending the advertisement packet to the user device and a display application module for displaying the display message on a display proximate to the user device. The display message may be for providing information for a user of the user device about the advertisement packet sent to the user device. In some embodiments, the display message may alert the user to look at the user device. The display message may also comprise information for enabling reception of advertisement packets at the user device. In certain embodiments, the display message may comprise information about a benefit in receiving the advertisement packet. For example, the display message may be a still image, video, or animation informing the user that a coupon may be available on their user device. Alternatively or additionally, the display message may comprise any suitable information that may assist in increasing the effectiveness of an advertising campaign.

The display may be located proximate to a user device to increase the effectiveness of a display message displayed on the display. Being proximate to the user device, for the purposes of the present disclosure, means that the display is within viewing range of or is viewable by the user. The viewing range may be any suitable distance. For example, the display may be within a range of 0 to 50 feet of the user device.

In some embodiments, the display message may be displayed on the beacon device (for the purposes of the present disclosure, the BLE peripheral device and beacon device are used interchangeably). For example, the display may be integrated with the beacon device. In certain embodiments, the beacon device may be incorporated within a TV or monitor, either as part of the control circuitry or as an optional add-on module, providing the TV or monitor with the capability to transmit BLE advertisement packets and display a display message corresponding to the advertisement packets. Incorporating the beacon device with the display is advantageous because it saves the costs of producing separate devices and saves the time and effort of placing and keeping track of beacon devices separately from displays. Since the advertisement packet may be used to promote goods and services based on location, it may be beneficial to have a display message corresponding to the advertisement packet be displayed within the vicinity of the beacon device transmitting the advertisement packet. An operator or an advertiser may need to keep track of beacon devices and signage displays to make sure that signage displays that are displaying a display message corresponding to an advertisement packet are within a certain range of the beacon device transmitting that advertisement packet. Incorporating the beacon device with the display may simplify the tracking process. Additionally, updating the display message and the advertisement packet may be done simultaneously. For example, an ID of the display may be used to update the display message and the contents of the advertisement packet at a remote dashboard.

The beacon device may comprise a computer and the computer may comprise one or more processors or microprocessors, such as a central processing unit (CPU). The processor performs arithmetic calculations and control functions to execute software stored in a computer readable memory. The computer readable memory may be an internal memory, such as one or both of random access memory (RAM) and read only memory (ROM), and possibly additional memory. The additional memory may comprise, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory may be physically internal to the computer, or external as shown or both. The processor may retrieve items, such as applications and data lists, stored on the additional memory and move them to the internal memory, such as RAM, so that they may be executed or to perform operations on them.

The beacon device may also comprise other similar interfaces for allowing computer programs or other instructions to be loaded. Such interfaces may comprise, for example, a communications interface or transmitter that allows software and data to be transferred between the beacon device and external systems and networks, such as an application server or a user device. Examples of the communications interface comprise a modem, a network interface such as an Ethernet card, a wireless communication interface, or a serial or parallel communications port. Software and data transferred via the communications interface are in the form of signals which may be electronic, acoustic, electromagnetic, optical, or other signals capable of being received by the communications interface. Multiple interfaces, of course, may be provided on the beacon device.

In some embodiments, the beacon device may also comprise a display and a graphical processing unit (GPU). The various components of the device may be coupled to one another either directly or indirectly by shared coupling to one or more suitable buses.

Communication between the beacon device and the user device may be one-way communication of an advertisement packet via BLE signals transmitted by the beacon device.

The BLE advertisement packet may comprise a unique beacon ID or web page URL. Upon reception of a BLE advertisement packet containing a unique beacon ID, a user device, such as a Smartphone, Smartwatch, tablet or laptop, may perform a lookup within a 3rd party server on the internet to determine a predefined action to be taken. Actions may comprise, for example, launching of an app, launching of an app with an additional message to the app to open a specific app screen or launching of a web browser with an additional message to the web browser to open a specific web page. Upon reception of a BLE advertisement packet containing a URL, a user device may launch a web browser with an additional message to the web browser specifying the URL of a web page for the browser to open. In certain embodiments, the beacon device may simultaneously transmit multiple identifiers within multiple packet formats. For example, a beacon in the Google Eddystone UID format and a beacon in the Apple iBeacon format may be transmitted simultaneously (within less than 1 second of each other) to signal both Android and Apple devices of promotions nearby. In another example, a beacon in the Google Eddystone URL format and a beacon in the open standard Altbeacon format may be transmitted simultaneously to signal Android apps to open a specific web page or apps in any Smartphone type (Windows, Blackberry, Android or Apple) to take a specific action such as display product information or a coupon.

In some embodiments, the advertisement packet communicated by the beacon device may comprise an identifier for identifying the geographic location from which the packet is being sent. The geographic location that the beacon device is linked to may represent products or services located at that particular geographic location. Actions taken by a user device application in response to receiving the identifier may include providing promotional information for products or services at the geographic location of the beacon device.

In some embodiments, the system may include an application server. The application server may include a server application for configuring a 3rd party lookup server that is communicatively coupleable to the user device. As discussed above, the 3rd party lookup server may send instructions to the user device in response to the advertising packet that includes a specific ID being received by the user device. The instructions may include, for example, configurable instructions instructing the user device to perform an action, such as launching an app.

In certain embodiments the system may comprise user device application instructions stored on a server memory of the application server. These instructions may be used for configuring a third party lookup server for instructing a user device application to display information about an advertising promotion in response to the beacon identifier being received by the user device.

To determine what action to take upon reception of an advertisement packet with specific beacon ID, some user devices may query a 3rd party server on the internet. This server may be updated to associate actions to IDs. A web service interface to these servers may support updates to the actions taken by user devices when they receive advertisement packets that contain beacon IDs. To configure a campaign (what is currently running on a screen and what actions are taken on a user device when it receives the currently broadcast beacon ID) requires that operators keep track of IDs, actions, and screen contents. To make this process more efficient, beacon IDs and actions to be taken by user devices when these IDs are received may be combined and given a label within the dashboard. When configuring advertising content, operators may simply select the required ID/action combination along with a display message that may include a set of images, videos, and 2D/3D animations. As a result, display messages and advertisement packets comprising beacon IDs broadcast from beacon devices may change. Moreover, the 3rd party server may be updated (in real time) to support the action that has been associated with the beacon ID.

In some embodiments, an advertiser may have several beacon devices in a single retail location or multiple retail locations, each with a unique display message or display messages and each sending a unique advertisement packet, such as a beacon ID or web page URL, over BLE. In some embodiments, each beacon device may be updated with a unique display message and beacon ID or web page URL within an advertisement packet using the beacon device's device address. Device addresses may be any identification on the device that is unique, including (but not limited to) an Ethernet MAC address, Wi-Fi MAC address or Cellular ID that may comprise, for example, International Mobile Equipment ID (IMEI), Mobile Equipment ID (MEID), Electronic Serial Number (ESN), International Mobile Subscriber Identity (IMSI), Mobile Serial Number (MSN) or Subscriber Identification Module (SIM).

In certain embodiments, the system may include an updating application stored on an application server and/or the beacon device. The updating application may include a configurable function for updating the advertisement packet and the display message. An advertiser may configure the function to update the advertisement packet and the display message for different promotional events. In some embodiments, updating the advertisement packet may include updating an advertisement packet ID.

In certain embodiments, advertisers may update beacon devices through a remote “dashboard” that allows the beacon device content to be updated using, for example, graphic controls. An advertiser may also choose to display the same display message and send the same advertisement packet over BLE on more than one beacon device. In this case, the advertiser may link all devices displaying the same content by grouping the devices based on their device address through the remote dashboard, and may update all beacon devices at the same time.

In some embodiments, updates may be configured within an internet-based server by advertisers using a web browser or application. Beacon devices may periodically poll the internet-based server to read configuration updates after they are entered by the advertiser. In certain embodiments, the server may notify beacon devices of updates. Advertisers may setup configuration changes for a single device or selected set of devices, or all devices under their control.

In some embodiments, the updating application may comprise a scheduling module for automatically updating the advertisement packet and the display message based on a configurable schedule. Advertiser promotions may be more effective at different times of the day, days of the week or seasons. To increase the effectiveness of promotions, advertisers may want to schedule the displaying of the display message and the transmission of advertisement packets containing beacon IDs and web page URLs that are linked to an advertiser's apps, app screens or web pages, at different times of the day, days of the week or seasons. Advertisers may want to schedule the launch of different apps, display of different app screens or web pages at times that may increase advertising effectiveness. The advertiser may manually enter schedules on an application server, such as an internet based server, which may then be uploaded to the beacon device.

In addition, by using time and sales volume statistics on which advertisement packets were used to launch an app, launch an app with a specific app screen or navigate to a web page, AI-based adaptive scheduling may be used to automatically schedule the display of the display message and the transmission of advertisement packets containing beacon IDs and web page URLs. To gather these statistics, IDs and web page URLs unique to an advertiser's promotion or campaign may be used. For example, in certain embodiments, an application may communicate with a server on the cloud to access data for the promotion or campaign, and this activity along with URL web page hits may be logged and correlated with the time of day, day of the week, season of the year, and user profile. From these statistics, short-term and long-term trends may be derived to predict which promotions should be run at a specific time of day, day of the week, or season of the year.

In some embodiments, the updating application may comprise an adaptive scheduling module for automatically updating the advertisement packet and the display message according to an adaptive schedule. The adaptive schedule may be automatically derived from sales data for an advertised product or service. For example, a monitoring application may monitor sales data related to an advertising campaign. A sales analysis application at an application server communicatively coupled to the beacon device may automatically analyse the sales data and automatically configure the schedule based on the sales data. Analysing sales data may include comparing a quantity of sales during different periods of time. Any suitable period of time may be used, such as, for example, hours during a day, days during a week or seasons of the year.

In some embodiments, instead of or in addition to querying a 3rd party server to determine a required action upon beacon ID reception, a user device may query coupon files that users have downloaded and saved on their user device within a user device wallet application. Wallet app coupons may support user notification when a beacon ID matching a beacon ID stored within the wallet coupon is received by the user device. To streamline creation and inclusion of beacon IDs within coupons, the present disclosure supports coupon creation within the dashboard and labeled beacon IDs may be selected for addition within coupons. Labels may describe a promotion (e.g. label: “20% off men's t-shirts”) and may be more meaningful than a numeric ID. Additionally, multiple beacon IDs may be grouped and entire groups of IDs may be selected (e.g. group “men's clothing” including IDs with labels “men's t-shirts”, “men's pants” and “men's underwear”) and included within coupon files upon creation for notification if any of the beacon IDs defined within the group are received by the user device. Groups may be defined outside of the coupon for selection within a coupon upon its creation, making the process more streamlined and efficient.

In certain embodiments, a coupon application may be stored at the application server. The coupon application may allow an advertiser or operator to add an ID to a coupon file. Any suitable application for creating or updating coupon files may be used as a coupon application. For example, a content management system may be used as a coupon application.

The coupon file, which may comprise a coupon, may be transmittable to a third party lookup server and to a user device from the third party lookup server. Any suitable file transfer method may be used to transfer the coupon file to the user device. For example, a user may download the coupon from the third party lookup server. In some embodiments, the user may receive an email containing the coupon file as an attachment. The coupon file may be stored on a wallet app on the user device.

Any suitable ID may be used to link or correlate a coupon with an advertisement packet. For example, in some embodiments, the ID in the coupon file may match a beacon ID in an advertisement packet. When the user device receives the advertisement packet, an application on the user device may check if the ID in the advertisement packet corresponds with an ID in a currently stored coupon. If it does, the application may notify the user on the lock screen or notification center. If the user selects the notification indicating that they want to see the coupon, the wallet app may be shown on the screen and the coupon may be shown within the wallet app. The application on the user device may be any suitable application. It may comprise, for example, an operating system of the user device. In some embodiments, the application may be an application specifically configured to receive IDs and check them against IDs contained in coupon files.

Allowing advertisers to create coupon files with IDs that match beacon IDs contained in advertisement packets is advantageous because it allows for targeted promotions and advertising. For example, a user may be in the parking lot of a store that has a beacon device. The user device may receive the advertisement packet and launch a wallet app showing the coupon. The user may see the coupon and be persuaded to visit the store.

In some embodiments, a display message explaining or showing users how to activate or receive coupons on their user devices may be displayed. The display may be part of a beacon device transmitting advertising packets containing beacon IDs for launching a wallet app with a coupon for use at the location of the beacon device.

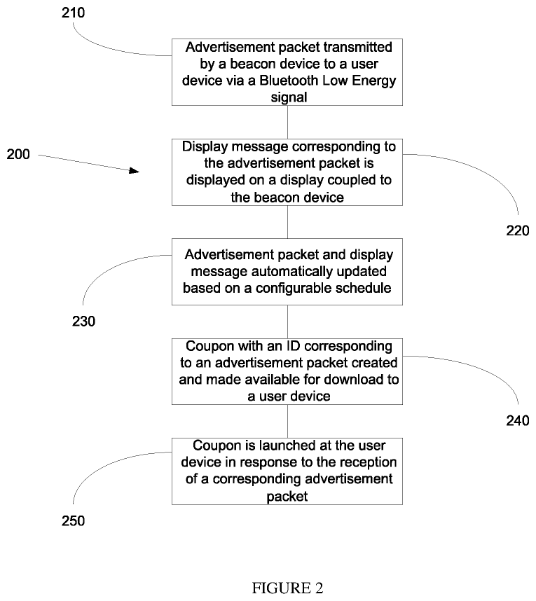

Referring to FIG. 2, there is provided a method 200 for localized wireless advertising. At box 210, an advertisement packet stored on a computer readable memory coupled to a beacon device is transmitted as a BLE communications signal from a communications interface coupled to the beacon device to a user device. At box 220, a display message corresponding to the advertisement packet is displayed on a display communicatively coupled to the beacon device. The display message may provide information about the advertisement packet to a user of the user device. For example, the display message may provide information on enabling reception of the advertisement packet by the user device. In some embodiments, the display message may provide further information about a promotion that the advertisement packet is related to.

At box 230, the advertisement packet and display message may be automatically updated based on a configurable schedule. The configurable schedule may be based on previous sales data.

At box 240, a coupon is created at an application server and uploaded to a third party lookup server. A beacon ID matching a beacon ID contained in an advertisement packet is included in the coupon. The coupon is available for download by a user.

At box 250, an advertisement packet comprising the matching beacon ID is received by a user device. An application on the user device matches the ID in the advertisement packet with the beacon ID in the coupon and launches a wallet app containing the coupon. The coupon may be redeemable at the location that the user is at.

The terminology used herein is for the purpose of describing particular embodiments only and is not intended to be limiting. Accordingly, as used herein, the singular forms “a”, “an” and “the” are intended to include the plural forms as well, unless the context clearly indicates otherwise. It will be further understood that the terms “comprises” and “comprising,” when used in this specification, specify the presence of one or more stated features, integers, steps, operations, elements, and components, but do not preclude the presence or addition of one or more other features, integers, steps, operations, elements, components, and groups.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A system for transmitting advertising packets, the system comprising:
(a) a device, the device comprising a computer readable memory and a processor;
(b) a communications interface coupled to the device and communicatively coupleable with a user device, the communications interface operable to transmit a Bluetooth Low Energy communications signal;
(c) an advertisement packet stored on the computer readable memory;
(d) a display message corresponding to the advertisement packet, the display message stored on the computer readable memory;
(e) a display communicatively coupled to the device for displaying the display message;
(f) an application stored on the computer readable memory and executable by the processor, the application comprising:
(i) an advertising routine for sending the advertisement packet to the user device;
(ii) a display application module for displaying the display message on the display, wherein the display is proximate to the user device and the display message is for providing information for a user of the user device about the advertisement packet sent to the user device.

2. The system of claim 1, or any other claim herein, wherein the advertisement packet comprises an identifier for identifying the geographic location from which the packet is being sent.

3. The system of claim 2, or any other claim herein, wherein the device simultaneously transmits multiple identifiers within multiple packet formats.

4. The system of claim 1, or any other claim herein, wherein the display message comprises information about enabling reception of the advertisement packet at the user device.

5. The system of claim 1, or any other claim herein, wherein the display message comprises information about a benefit in receiving the advertisement packet.

6. The system of claim 1, or any other claim herein, further comprising an application server wherein the application server comprises a server application for configuring a third party lookup server, the third party lookup server communicatively coupleable to the application server and the user device, for instructing the user device to take an action in response to a beacon identifier within the advertisement packet being received by the user device.

7. The system of claim 6, or any other claim herein, further comprising user device application instructions stored on a server memory of the application server for configuring the third party lookup server for instructing the user device application to display information about an advertising promotion in response to the beacon identifier being received by the user device.

8. The system of claim 6, or any other claim herein, further comprising user device wallet application instructions stored on a server memory of the application server for configuring the third party lookup server for instructing the user device wallet application to display a specific coupon in response to the beacon identifier received by the user device.

9. The system of claim 6, or any other claim herein, further comprising an updating application stored on the application server and the device, the updating application comprising a configurable function for updating the advertisement packet and the display message.

10. The system of claim 9, or any other claim herein, wherein updating the advertisement packet comprises updating an advertisement packet identifier.

11. The system of claim 9, or any other claim herein, wherein the updating application comprises a scheduling module for automatically updating the advertisement packet and the display message based on a configurable schedule.

12. The system of claim 1, or any other claim herein, wherein the display is integrated with the device.

13. The system of claim 9, or any other claim herein, wherein the updating application comprises an adaptive scheduling module for automatically updating the advertisement packet and the display message according to an adaptive schedule automatically derived from sales data for an advertised product or service.

14. The system of claim 6, or any other claim herein, further comprising a coupon creation application stored at the application server for creating a coupon file and adding an identifier to the coupon file, the coupon file being transmittable to the user device and the identifier matching the beacon identifier in the advertisement packet.

15. The system of claim 9, or any other claim herein, further comprising a user device application stored on the user device, the user device application comprising a user device module executable in response to the user device receiving the advertisement packet, wherein the user device is communicatively coupleable to the application server for updating the user device application.

16. The system of claim 1, or any other claim herein, wherein the device comprises a plurality of devices.

17. A method for localized wireless advertising, the method comprising:
(a) sending an advertisement packet stored on a computer readable memory coupled to a beacon device to a user device proximate to the beacon device, wherein the advertisement packet is sent as part of a Bluetooth Low Energy communications signal transmitted by the beacon device; and
(b) displaying a display message corresponding to the advertisement packet on a display communicatively coupled to the beacon device, the display message providing information for a user of the user device about the advertisement packet sent to the user device.

18. The method of claim 17, or any other claim herein, wherein providing information for the user of the user device comprises alerting the user to the advertisement packet sent to the user device.

19. The method of claim 17, or any other claim herein, further comprising providing an updating application at an application server communicatively coupled to the beacon device, the updating application operable for updating the advertisement packet and the display message.

20. The method of claim 19, or any other claim herein, wherein the beacon device comprises a plurality of beacon devices, each beacon device having stored thereon a corresponding advertisement packet and message and wherein the updating application is operable for updating with a first update a first corresponding advertisement packet and display message at a first one of the plurality of beacon devices and with a second update a second corresponding advertisement packet and second message at a second one of the plurality of beacon devices.

21. The method of claim 17, or any other claim herein, further comprising providing a configurable schedule and automatically transmitting the advertisement packet based on the configurable schedule.

22. The method of claim 21, or any other claim herein, further comprising monitoring sales data related to an advertising campaign and providing a sales analysis application at an application server communicatively coupled to the beacon device for automatically analysing the sales data and automatically configuring the schedule based on the sales data.

23. The method of claim 22, or any other claim herein, wherein analysing sales data comprises comparing a quantity of sales during different periods of time.

24. The method of claim 17, or any other claim herein, wherein displaying the message on the display comprises displaying the message on the beacon device.

25. The method of claim 19, or any other claim herein, further comprising transmitting from the application server an update to a user device application stored on the user device.

26. The method of claim 14, or any other claim herein, wherein the updating application is further operable for configuring a response of the user device application to the receipt of the advertisement packet by the user device.

27. The method of claim 17, or any other claim herein, wherein displaying the display message comprises displaying a message instructing the user on enabling reception of the advertisement packet at the user device.

28. The method of claim 27, or any other claim herein, wherein the message comprises at least one of an image, a video or an animation.

29. A computer program product for localized wireless advertising, the computer program product comprising a non-transitory computer-readable medium having computer-readable code embodied therein executable by a processor for performing a method for localized wireless advertising, the method comprising:
(a) transmitting a Bluetooth Low Energy communications signal from a communications interface coupled to a beacon device;
(b) sending an advertisement packet stored on a computer readable memory coupled to the beacon device to a user device proximate to the beacon, wherein the advertisement packet is sent as part of the Bluetooth Low Energy communications signal; and
(c) displaying a message corresponding to the advertisement packet on a display communicatively coupled to the beacon device, the message providing information for a user of the user device about the advertisement packet sent to the user device.
